(19) United States
(12) Patent Application Publication
(10) Pub. No.: US 2010/0287245 A1
(43) Pub. Date: Nov. 11, 2010

(54) METHOD FOR REMOTELY CONTROLLING DIGITAL PHOTO FRAME

(75) Inventor: PENG-ZHENG YANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/508,589

(22) Filed: Jul. 24, 2009

(30) Foreign Application Priority Data
May 11, 2009 (CN) 200910302213.9

(51) Int. Cl. G06F 3/01; G06F 15/16

(52) U.S. Cl. 709/206; 715/740; 709/227

(57) ABSTRACT

A method for remotely controlling a digital photo frame is provided. The method includes the following steps: the digital photo frame and an instant messaging client are connected to a network; establish communication between the digital photo frame and the instant messaging client; the instant messaging client sends a command to the digital photo frame by the instant; the digital photo frame receives the command and performs the command.

### BACKGROUND

1. Technical Field

The present disclosure relates to remote control methods, and particularly, to a method for remotely controlling a digital photo frame.

2. Description of Related Art

Digital photo frames are popularly used for showing photos. Typically, different types of digital photo frames have different operating interfaces. And, the operating interface for each different type of digital photo frame is usually unique. When in use, users need to become familiar to the unique operating interfaces before using different types of digital photo frames, which is time consuming and inconvenient.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic diagram of a system for performing one embodiment of a remotely controlling method for a digital photo frame.

FIG. 2 is a flowchart of the remotely controlling method for the digital photo frame of FIG. 1.

### DETAILED DESCRIPTION

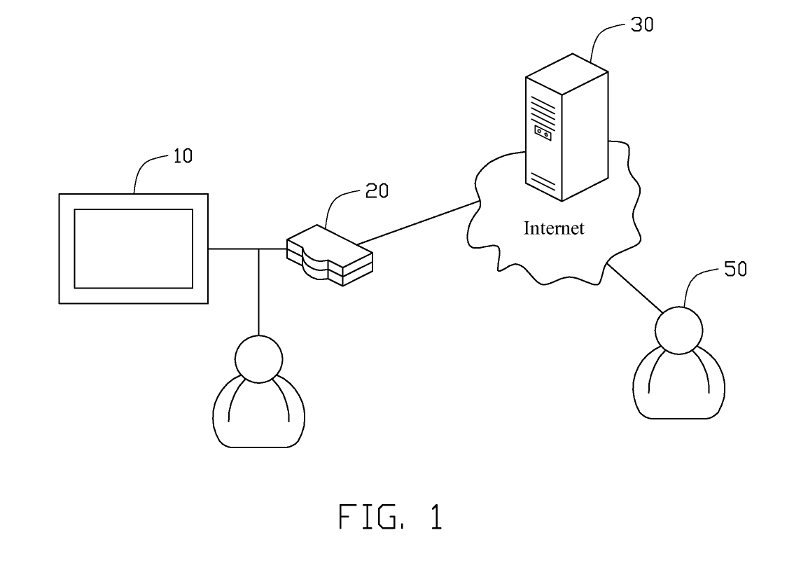

Referring to FIG. 1, an embodiment of a remotely controlling method of a digital photo frame (DPF) 10 is provided. An instant messaging software (such as the MSN messenger, etc.) is installed in the DPF 10. The DPF 10 is connected to a network, and communicates with an instant messaging server 30 via a router 20. An instant messaging client 50 (such as a computer with an instant messaging software) also communicates with the instant messaging server 30. The instant messaging client 50 and the DPF 10 are located in the same network, such as the Internet, or a local area network.

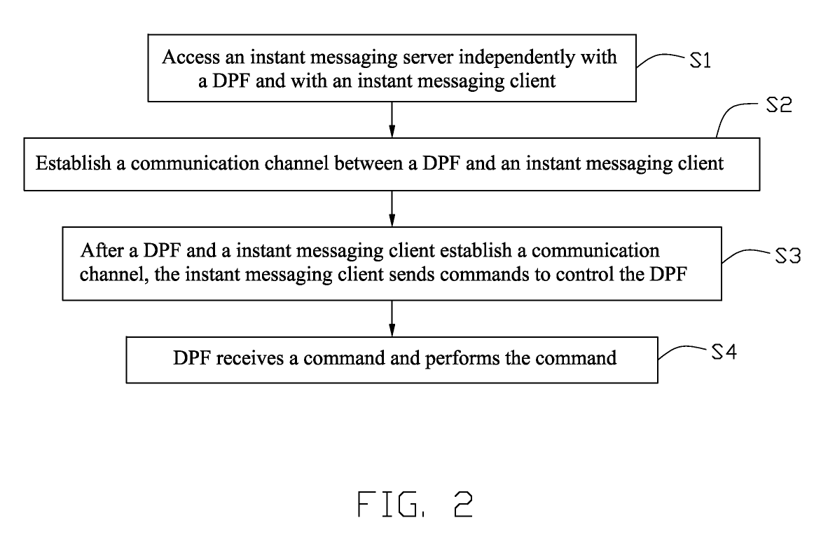

Referring to FIG. 2, the remotely controlling method includes following steps:

Step S1: accessing the instant messaging server 30 independently with the DPF 10 and with the instant messaging client 50 via an authentication method such as using username and password.

Step S2: Establishing a communication channel between the DPF 10 and the instant messaging client 50. The communication channel can be established by one of the following ways:

1. The DPF 10 requests to establish a communication channel with the instant messaging client 50. In detail, after the DPF 10 is connected to the instant messaging server 30, the DPF sends a DPF connection request to the instant messaging client 50. When the instant messaging client 50 is connected to the instant messaging serve 30, the instant messaging client 50 receives the DPF connection request from the instant messaging server 30. Once the instant messaging client 50 accepts the request, the messaging client 50 and the DPF 10 establish the communication channel with each other.

2. The instant messaging client 50 requests to establish a communication channel with the DPF 10. In detail, after the instant messaging client 50 is connected to the instant messaging server 30, the instant messaging client 50 sends an instant message client connection request to the DPF 10. When the DPF 50 is connected to the instant messaging server 30, the DPF 10 receives the instant messaging client connection from the instant messaging server 30. Once the DPF 10 accepts the request, the messaging client 50 and the DPF 10 establish communication channel with each other.

Step S3: After the DPF 10 and the instant messaging client 50 establish the communication channel, the instant messaging client 50 sends commands to control the DPF 10. The instant messaging client 50 is capable of controlling the DPF 10 to perform in one of the following manners:

1. The instant messaging client 50 commands the DPF 10 to upgrade the DPF firmware by sending a firmware image file to the DPF 10 via the instant messaging server 30. The DPF 10 receives the firmware image file and upgrades the firmware according to the command. After the upgrade is completed, the DPF 10 sends a firmware upgrade result to the instant messaging client 50 via the instant messaging server 30.

2. the instant messaging client 50 sends a picture uploading command to the DPF 10 and uploads the picture to the DPF 10 via the instant messaging server 30. The DPF 10 receives the picture and adds the picture file to a picture album of the DPF 10. Then, the DPF 10 informs the instant messaging client 50 the picture upload result.

3. The instant messaging client 50 sends a command to the DPF 10 to establish voice communication between the instant messaging client 50 and the DPF 10 via the instant messaging server 30.

4. The instant messaging client 50 sends a command to the DPF 10 to establish video communication between the instant messaging client 50 and the DPF 10 via the instant messaging server 30.

5. the DPF 10 receives text-based commands from the instant messaging client 50 and performs the text-based commands. A detailed exemplary list of commands are shown in the following table:

| Commands | Function Indication |
|---|---|
| ? [cmd] | Request the DPF 10 to show help |
| | information about a [cmd] command. If |
| | the [cmd] is undefined, showing the help |
| | information of all commands. |
| help [cmd] | Same as command “?” |
| ls [dir] | Display a list of files which locate in [dir] |
| gelete [filename] | Delete the [filename] file in the DPF 10 |
| get [filename] | Request the DPF 10 to send the file of |
| | [filename] to the instant messaging client |
| | 50 |
| ver | Display the firmware version of the DPF 10 |
| play [filename] | Play the file of [filename] |
| slideshow | Play the file in slideshow |
| shutdown | Shut down the DPF 10 |
| reboot | Restart the DPF 10 |
| sudo [cmd] | Request the DPF 10 to execute the [cmd] |
| | command |
| mkdir [dir] | Request the DPF 10 to establish a catalog |
| | [dir] |
| rmdir [dir] | Request the DPF 10 to delete the catalog |
| | [dir] |
| volume [up\|down\|n] | Request the DPF 10 to adjust volume up or |
| | down |
| brightness [up\|down\|n] | Request the DPF 10 to adjust brightness of |
| | screen up or high |
| pwd [password] | Set login password for the DPF 10 |
| safe [on\|off] | Set safe mode for the DPF 10, [on] presents |
| | that the DPF 10 needs to confirm password |
| | with the instant messaging client 50 before |
| | executing any command, [off] presents not |
| | need. |

Step S4: The DPF 10 responds to the command and activates an operation corresponding to the command.

As described above, the present remotely controlling method for the digital photo frame enables users to operate the digital photo frame in familiar instant messaging software interfaces, thereby saving time for learning the unique operating interface of the digital photo frame.

It is to be understood that the above description and the claims drawn to a method may include some indication in reference to certain steps. However, the indication used is only to be viewed for identification purposes and not as a suggestion as to an order for the steps.

What is claimed is:

1. A method for remotely controlling a digital photo frame, comprising:
connecting the digital photo frame to a network;
connecting an instant messaging client to the network;
establishing communication channel between the digital photo frame and the instant messaging client;
sending a command to the digital photo frame by the instant messaging client; and
receiving the command and performing according to the command by the digital photo frame.

2. The method for remotely controlling the digital photo frame of claim 1, further comprising sending a connection request to the instant messaging client by the digital photo frame; and accepting the connection request by the instant messaging client, to establish a communication channel between the digital photo frame and the instant messaging client.

3. The method for remotely controlling the digital photo frame of claim 1, further comprising sending a connection request to the digital photo frame by the instant messaging client; and accepting the connection request by the digital photo frame, to establish communication channel between the digital photo frame and the instant messaging client.

4. The method for remotely controlling the digital photo frame of claim 1, further comprising informing the instant messaging client after the digital photo frame completes the operation.

5. The method for remotely controlling the digital photo frame of claim 1, wherein the instant messaging client sends the command to the digital photo frame via an instant messaging server.

6. The method for remotely controlling the digital photo frame of claim 5, wherein the instant messaging client and the digital photo frame independently access the instant message server via username and password.

7. The method for remotely controlling the digital photo frame of claim 5, wherein the command is for controlling the digital photo frame to upgrade a firmware thereof.

8. The method for remotely controlling the digital photo frame of claim 7, wherein the instant messaging client sends a firmware image file to the digital photo frame via the instant messaging server; and the digital photo frame receives the firmware image file and responds to the firmware upgrading command.

9. The method for remotely controlling the digital photo frame of claim 5, wherein the command is for controlling the digital photo frame to establish voice communication between the instant messaging client and the digital photo frame.

10. The method for remotely controlling the digital photo frame of claim 5, wherein the command is for controlling the digital photo frame to download a picture file from the instant messaging client and add the picture file into a picture album in the digital photo frame.

11. The method for remotely controlling the digital photo frame of claim 5, wherein the command is for controlling the digital photo frame to establish video conference with the instant messaging client.

12. The method for remotely controlling the digital photo frame of claim 5, wherein the digital photo frame receives text-based commands from the instant messaging client and performs the commands.

13. The method for remotely controlling the digital photo frame of claim 12, wherein the text-based commands comprise a command for controlling the digital photo frame to delete a file in the digital photo frame.

14. The method for remotely controlling the digital photo frame of claim 12, wherein the text-based commands comprise a command for controlling the digital photo frame to slideshow the photos in the digital frame.

15. The method for remotely controlling the digital photo frame of claim 12, wherein the text-based commands comprise a command for controlling the digital photo frame to adjust the volume when the digital photo frame play music.

16. The method for remotely controlling the digital photo frame of claim 12, wherein the text-based commands comprise a command for setting the digital photo frame in a safe mode; and a text-based command “on” is used to require the digital photo frame to confirm password to the instant messaging client before executing any operation.

17. The method for remotely controlling the digital photo frame of claim 12, wherein the text-based commands comprise a command for controlling the digital photo frame to re-start.
